(19) United States
(12) Patent Application Publication
(10) Pub. No.: US 2007/0163728 A1
(43) Pub. Date: Jul. 19, 2007

(54) Blind lift cord locking structure

(76) Inventor: Ming Nien, Taipei (TW)

Correspondence Address: LEONG C LEI, PMB # 1008, 1867 YGNACIO VALLEY ROAD, WALNUT CREEK, CA, 94598, US

(21) Appl. No.: 10/005,698

(22) Filed: Dec. 7, 2001

(51) Int. Cl. E06B 9/38

(52) U.S. Cl. 160/178.1 R

(57) ABSTRACT

A venetian blind lift cord locking structure to fasten one end of the lift cord, is comprised of a plate having a hole; a cut in the plate to one end of the hole, and end surfaces formed on both sides of the cut being tightly close to each other so that once the pull applied to the lift cord exceeds a specific value, the lift cord is released to prevent from accident due to trip or tangle by the lift cord.

### BACKGROUND OF THE INVENTION

(a) Field of the Invention

The present invention is related to a blind lift cord locking structure, and more particularly, to one that releases the lift cord once the pull applied to it exceeds a specific value to prevent from accident due to trip or tangle by the lift cord.

(b) Description of the Prior Art

As illustrated in FIGS. 1 and 2 of the accompanying drawings, a roller blind of the prior art is comprised of a head rail (10), a shade (11); more than one lift cords (12) suspending from the head rail (10), and a hem (13) to the lower edge of the shade (11). Wherein, one end of the lift cord (12) is fixed to the head rail (10) while the other end coming under the hem (13), penetrating through the head rail (10), leaving a positioning device (14) provided in the head rail (10) to suspend down to the lower edge of the blind for the user to pull and roller up the shade (11).

Referring to FIGS. 3 and 4 for a venetian blind of the prior art, the venetian blind is comprised of a head rail (20); more than one cords (21) suspending from the head rail (20); multiple slats (22); a bottom rail (23); more than one lift cords (24) penetrating each and all those slats (22) and suspending at equal spacing between the head rail (20) and the bottom rail (23); the lower end of each lift cord (24) being fixed to the bottom rail (23) with a locking block (25) while the other end penetrating and circumventing in the head rail (20), then leaving a positioning device (26) provided on one side of the head rail (20) to extend downward to reach below the bottom rail (23) for the user to pull to lift those blinds (22).

Either in the roller blind or the venetian blind as respectively illustrated in FIG. 2 and FIG. 4, one end of the lift cord (12 or 24) is fixed to the head rail (10) or the bottom rail (23) while the other end suspending down to where below the lower edge of the shade or blind, even lying on the floor. Either blind is usually provided at where children have easy access to it due to the location and height of the window, putting children high exposed to safety risks as they can be easily tripped or tangled by the lift cord (12 or 24), even strangled to death in some cases.

### SUMMARY OF THE INVENTION

The present invention is related to a blind lift cord locking structure, and more particularly, to one that releases the lift cord once the pull applied to it exceeds a specific value to prevent from accident due to trip or tangle by the lift cord.

The primary purpose of the present invention is to provide a blind locking structure to release its lift cord when subject to abnormal pull so to prevent people, particularly a child, from being tripped or tangled by the lift cord. To achieve the purpose, one end of the lift cord is fastened to the locking structure. The locking structure relates to a plate having a hole therein. One cut is provided on the plate to one end of the hole and end surfaces formed on both sides of the cut are made close to each other with a gap merely sufficient to release the lift cord when subject to abnormal pull to prevent tripping or tangling people.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a roller blind of the prior art;

FIG. 2 is a sectional view of an assembly of the roller blind of the prior art;

FIG. 3 is a perspective view of a venetian blind of the prior art;

FIG. 4 is a sectional view of an assembly of the venetian blind of the prior art;

FIG. 5 is an exploded view of a preferred embodiment of the present invention;

FIG. 6 is a sectional view of an assembly of the preferred embodiment of the present invention;

FIG. 7 is a perspective view showing a combination of a locking structure and a lift cord of the preferred embodiment of the present invention;

FIG. 8 is a schematic view showing an operation of the locking structure and the lift cord of the preferred embodiment of the present invention; and

FIG. 9 is a sectional view showing an assembly of another preferred embodiment of the present invention.

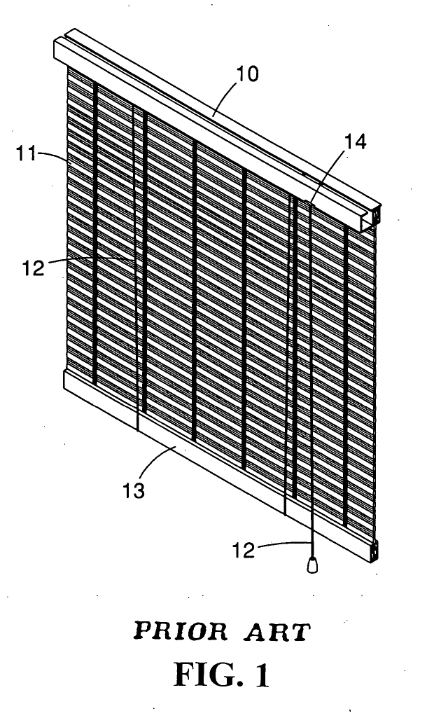

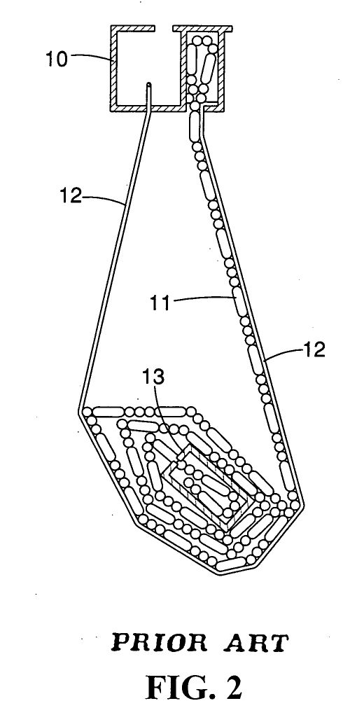

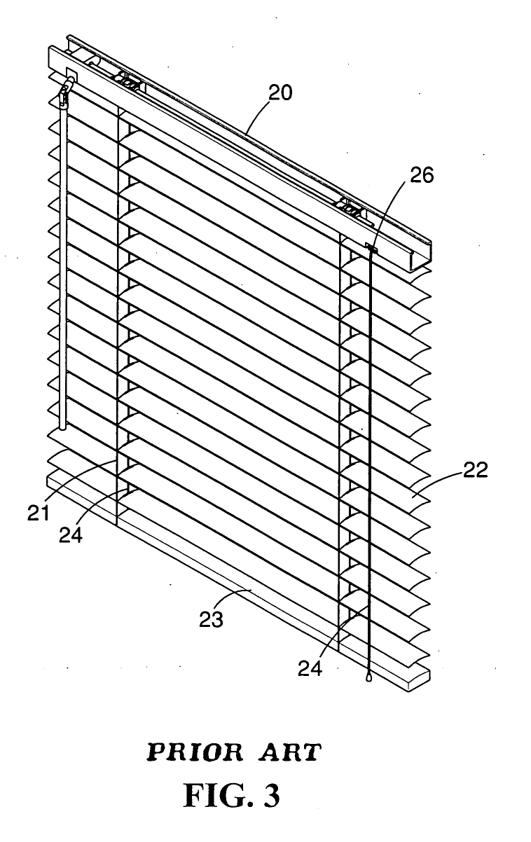

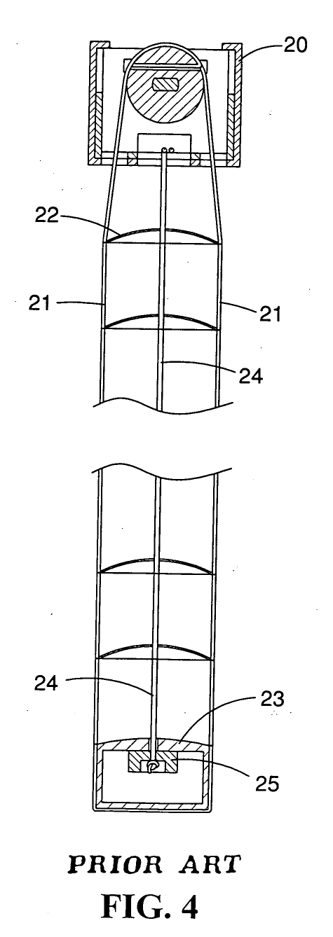

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

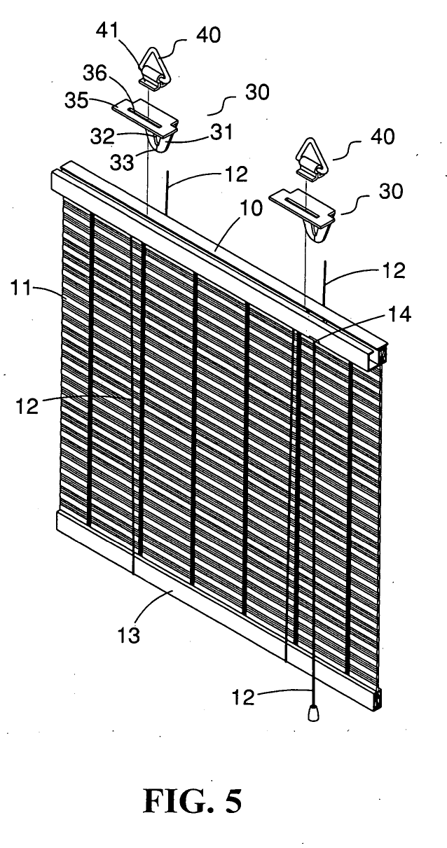

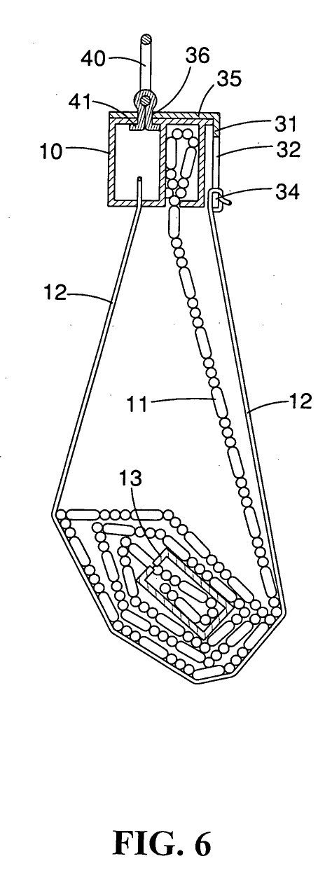

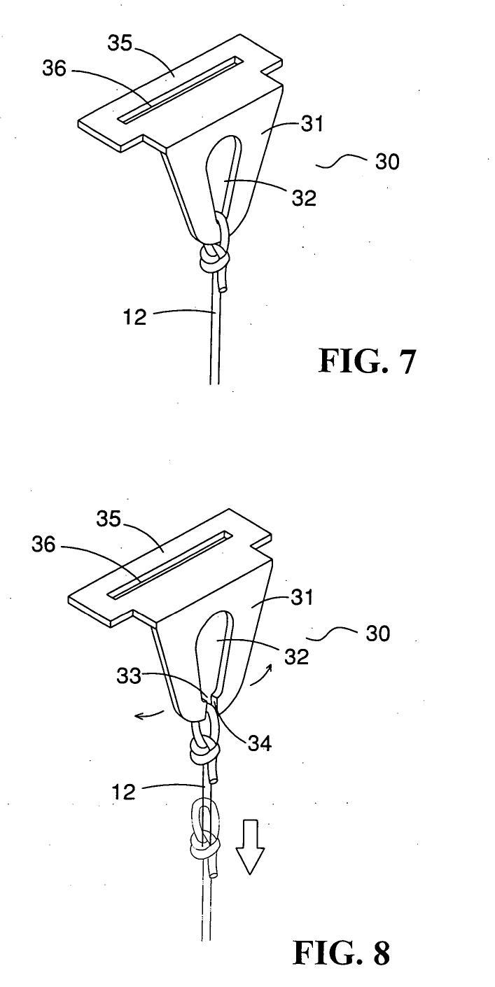

Referring to FIGS. 5, 6 and 7 for a first preferred embodiment of the present invention, a roller blind lift cord structure is provided to a head rail (10) to tie up one end of the lift cord. The locking structure is essentially comprised of a plate (31) having a hole (32) in a form of approximately a triangle up side down or a slot for one end of a lift cord (12) to be tied in. A cut (33) opening up to the outer edge of the plate (31) is provided at the lower end of the hole (32) in the plate (31). Two end surfaces (34) respectively formed on both sides of the cut (33) at where the end of the lift cord (12) is tied and fixed in the hole (32) are close to each other. A fixation plate (35) is vertically provided and connected to the locking plate (31). A slot (36) is provided in the fixation plate (35) to allow penetration of a seat (41) from a ring (40) to fix the fixation plate (35) to a head rail (10).

As illustrated in FIG. 8, when a pull applied to the lift cord (12) is greater than a specific value (approximately 15 lb.), the cut (33) of the locking plate (31) is forced to open up since the applied pull is greater than the clamping force between both end surface (34). As a result, the cut (33) releases the lift cord (33) from the locking plate (31).

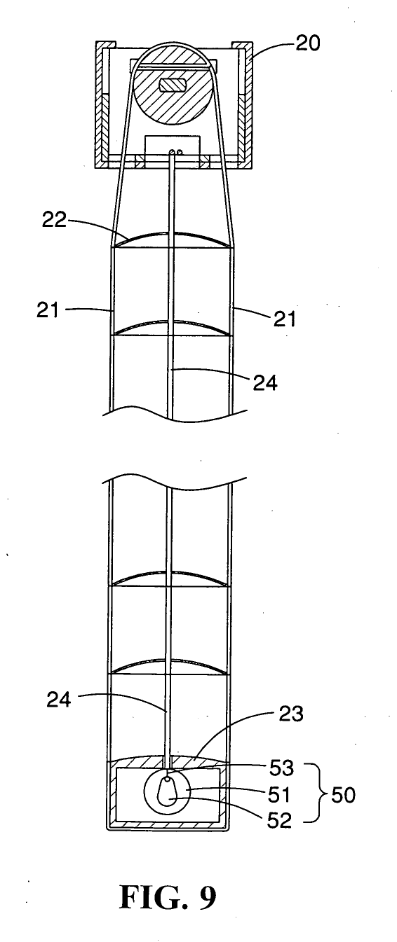

Now referring to FIG. 9, another preferred embodiment of the present invention is related to a locking structure for a venetian blind. Wherein, the locking structure (50) provided in a bottom rail (23) of the blind to tie up one end of a lift cord (24) is comprised of a locking plate (51) having a hole (52) approximately in a form of a triangle or of a slot to tie up one end of the lift cord (24). A cut (53) extending to the outer edge of the locking plate (51) is made at the upper end of the hole (52) in the locking plate (51). Two end surfaces formed by both sides of the cut (53) are close to each other.

Once the lift cord of the locking structure of the present invention is subject to an abnormal pull (a force greater than 15 lb.), the lift cord is automatically release to prevent people, particularly a child, from being tripped, tangled, or even strangled to death by the lift cord.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-6. (canceled)

7. A blind lift rod locking structure comprising:
a locking plate having a hole for one end of a lift cord to be tied in, said hole being in form of a triangle up side down, said plate having a cut at a lower end of said hole, two end surfaces respectively formed on both sides of said cut where said end of said lift cord is tied and fixed in said hole;
a fixation plate connected to said locking plate and having a slot; and
a seat engaged with said hole of said locking plate for fixing said fixation plate to head rail;
whereby when a pulling force applied to said lift cord is greater than a predetermined value, said cut is forced to open up to release said lift cord from said locking plate thereby preventing accident due to a tangle of said lift cord.
